(19) United States
(12) Patent Application Publication
(10) Pub. No.: US 2025/0139428 A1
(43) Pub. Date: May 1, 2025

(54) SYSTEMS AND METHODS FOR EFFICIENT MACHINE UNLEARNING

(71) Applicant: JPMORGAN CHASE BANK, N.A., New York, NY (US)

(72) Inventors: Guihong LI, Austin, TX (US); Hsiang HSU, Boston, MA (US); Richard CHEN, Baldwin Place, NY (US)

(21) Appl. No.: 18/493,962

(22) Filed: Oct. 25, 2023

(51) Int. Cl. G06N 3/08

(52) U.S. Cl. CPC G06N 3/08

(57) ABSTRACT

In some aspects, the techniques described herein relate to a method including: providing a machine unlearning algorithm, wherein the machine unlearning algorithm is configured to: approximate a final training state of model parameters trained with an unfiltered dataset; approximate a final training state of model parameters trained with a retain dataset; and compute a vector for shifting parameter weights from the final training state of model parameters trained with the unfiltered dataset to the final training state of model parameters trained with the retain dataset; tuning a batch normalization layer of a convolutional neural network included in a machine learning model with the machine unlearning algorithm, wherein parameters of a convolution layer of the convolutional neural network remain fixed; and tuning prompt parameters of a transformer model included in the machine learning model with the machine unlearning algorithm, wherein other parameters of the transformer model remain fixed.

### BACKGROUND

### 1. Field of the Invention

Aspects generally relate to systems and methods for efficient machine unlearning.

### 2. Description of the Related Art

The power of machine learning models has generated many concerns with respect to user privacy and data governed by copyright law. Jurisdictional copyright law is ubiquitous, and it is largely yet to be seen how such law will be applied to machine learning models. Moreover, privacy laws and regulations are becoming more widespread and comprehensive every day. This environment can pose significant risk to organizations that develop and utilize machine learning models that have been trained on (i.e., learned) and may generate output based on regulated or personal data. Retraining models from scratch with verified datasets can be an impractical solution for risk mitigation. Complicating matters further, often the original dataset that a model was trained on is unavailable (due, e.g., to an organization's data retention policy). Therefore, even if the time and resources for filtering regulated or other unwanted content from the original dataset was expendable, it is not possible to do so.

### SUMMARY

In some aspects, the techniques described herein relate to a method including: providing a neural-tangent-kernel-based (NTK-based) machine unlearning algorithm, wherein the NTK-based machine unlearning algorithm is configured to: approximate a final training state of model parameters trained with an unfiltered dataset; approximate a final training state of model parameters trained with a retain dataset; and compute a vector for shifting parameter weights from the final training state of model parameters trained with the unfiltered dataset to the final training state of model parameters trained with the retain dataset; tuning a batch normalization layer of a convolutional neural network included in a machine learning model with the NTK-based machine unlearning algorithm, wherein parameters of a convolution layer of the convolutional neural network remain fixed; and tuning prompt parameters of a transformer model included in the machine learning model with the NTK-based machine unlearning algorithm, wherein other parameters of the transformer model remain fixed.

In some aspects, the techniques described herein relate to a method, including: partitioning the unfiltered dataset into a forget dataset and the retain dataset;

In some aspects, the techniques described herein relate to a method, wherein the other parameters of the transformer model include parameters of an attention layer and parameters of an MSA layer.

In some aspects, the techniques described herein relate to a method, wherein the MSA layer includes an input query, a key, and values.

In some aspects, the techniques described herein relate to a method, wherein the prompt parameters of the transformer model are divided into key prompts and value prompts, and wherein the key prompts are prepended to the key of the MSA layer and the value prompts are prepended to the values of the MSA layer.

In some aspects, the techniques described herein relate to a method, wherein the NTK-based machine unlearning algorithm includes a matrix between the retain dataset and the forget dataset.

In some aspects, the techniques described herein relate to a method, wherein the matrix between the retain dataset and the forget dataset includes a matrix whose columns are gradients of a sample from the forget dataset.

In some aspects, the techniques described herein relate to a system including at least one computer including a processor and a memory, wherein the at least one computer is configured to: execute a neural-tangent-kernel-based (NTK-based) machine unlearning algorithm, wherein the NTK-based machine unlearning algorithm is configured to: approximate a final training state of model parameters trained with an unfiltered dataset; approximate a final training state of model parameters trained with a retain dataset; and compute a vector for shifting parameter weights from the final training state of model parameters trained with the unfiltered dataset to the final training state of model parameters trained with the retain dataset; tune a batch normalization layer of a convolutional neural network included in a machine learning model with the NTK-based machine unlearning algorithm, wherein parameters of a convolution layer of the convolutional neural network remain fixed; and tune prompt parameters of a transformer model included in the machine learning model with the NTK-based machine unlearning algorithm, wherein other parameters of the transformer model remain fixed.

In some aspects, the techniques described herein relate to a system, wherein the at least one computer is configured to: partition the unfiltered dataset into a forget dataset and the retain dataset;

In some aspects, the techniques described herein relate to a system, wherein the other parameters of the transformer model include parameters of an attention layer and parameters of an MSA layer.

In some aspects, the techniques described herein relate to a system, wherein the MSA layer includes an input query, a key, and values.

In some aspects, the techniques described herein relate to a system, wherein the prompt parameters of the transformer model are divided into key prompts and value prompts, and wherein the key prompts are prepended to the key of the MSA layer and the value prompts are prepended to the values of the MSA layer.

In some aspects, the techniques described herein relate to a system, wherein the NTK-based machine unlearning algorithm includes a matrix between the retain dataset and the forget dataset.

In some aspects, the techniques described herein relate to a system, wherein the matrix between the retain dataset and the forget dataset includes a matrix whose columns are gradients of a sample from the forget dataset.

In some aspects, the techniques described herein relate to a non-transitory computer readable storage medium, including instructions stored thereon, which instructions, when read and executed by one or more computer processors, cause the one or more computer processors to perform steps including: providing a neural-tangent-kernel-based (NTK-based) machine unlearning algorithm, wherein the NTK-based machine unlearning algorithm is configured to: approximate a final training state of model parameters trained with an unfiltered dataset; approximate a final training state of model parameters trained with a retain dataset; and compute a vector for shifting parameter weights from the final training state of model parameters trained with the unfiltered dataset to the final training state of model parameters trained with the retain dataset; tuning a batch normalization layer of a convolutional neural network included in a machine learning model with the NTK-based machine unlearning algorithm, wherein parameters of a convolution layer of the convolutional neural network remain fixed; and tuning prompt parameters of a transformer model included in the machine learning model with the NTK-based machine unlearning algorithm, wherein other parameters of the transformer model remain fixed.

In some aspects, the techniques described herein relate to a non-transitory computer readable storage medium, including: partitioning the unfiltered dataset into a forget dataset and the retain dataset;

In some aspects, the techniques described herein relate to a non-transitory computer readable storage medium, wherein the other parameters of the transformer model include parameters of an attention layer and parameters of an MSA layer.

In some aspects, the techniques described herein relate to a non-transitory computer readable storage medium, wherein the MSA layer includes an input query, a key, and values.

In some aspects, the techniques described herein relate to a non-transitory computer readable storage medium, wherein the prompt parameters of the transformer model are divided into key prompts and value prompts, and wherein the key prompts are prepended to the key of the MSA layer and the value prompts are prepended to the values of the MSA layer.

In some aspects, the techniques described herein relate to a non-transitory computer readable storage medium, wherein the NTK-based machine unlearning algorithm includes a matrix between the retain dataset and the forget dataset, and wherein the matrix between the retain dataset and the forget dataset includes a matrix whose columns are gradients of a sample from the forget dataset.

### BRIEF DESCRIPTION OF THE DRAWINGS

FIG. 1 is a block diagram of a system for efficient machine unlearning, in accordance with aspects.

FIG. 2 is a logical flow for efficient machine unlearning, in accordance with aspects.

FIG. 3 is a block diagram of a technology infrastructure and computing device for implementing certain aspects of the present disclosure, in accordance with aspects.

### DETAILED DESCRIPTION

Aspects generally relate to systems and methods for efficient machine unlearning.

Aspects described herein provide for systems and methods that allow a machine learning (ML) model to “forget,” or “unlearn” data in a specified dataset (e.g., a forget dataset). Aspects may unlearn regulated, private, or other sensitive data collected in a “forget dataset” of data, while preserving model performance with respect to learned data that is not present in the forget dataset (e.g., data in a “retain dataset”). This procedure is referred to as “machine unlearning” herein. Aspects describe an efficient neural-tangent-kernel-based (NTK-based) machine unlearning process for neural network-based models, such as classification models.

One reason whV conventional NTK-based unlearning algorithms are computationally inefficient is that they require computation of a Hessian matrix with respect to all of a model's weights. The time complexity for computing the Hessian matrix for a large model grows polynomially with the number of model parameters. For example, if a model has 100 million parameters, the corresponding Hessian matrix will have 1016 parameters. Performing calculations on this number of parameters is unmanageable in most, if not all, current infrastructures due to the intensive computation cost and large memory requirements. Accordingly, NTK-based unlearning algorithms are often applied on small models having relatively fewer parameters to keep computation of a corresponding Hessian matrix manageable.

Aspects described herein, however, may only apply an NTK-based unlearning algorithm to, and only compute a Hessian matrix for, a small fraction of a model's parameters, rather than on all model weights (as is currently the convention). Aspects may only compute a Hessian Matrix on a model's batch normalized layers and the model's prompts, while other parameters in the model remain fixed. By applying an NTK-based unlearning algorithm only on a model's batch normalization layers and prompts, the number of parameters in a corresponding Hessian matrix may be reduced to less than one percent (1%) of the number of parameters that must be computed with a conventional NTK-based process while having negligible effects on the performance of the unlearning procedure.

In accordance with aspects, given a neural network f and input x, after t training steps (or training sessions), the final output around the initial weights θ₀ may be approximately linearized as:

$${f}_{t} ( x ) \approx {f}_{t}^{lin} ( x ) = {f}_{0} ( x ) + {∇}_{θ} {f}_{0} ( x ) {\vert}_{θ = {θ}_{0}} {g}_{t} ,$$

$$x ∼ D$$

where gₜ=θₜ−θ₀. ∇_{θ}f₀(x)|_{θ=θ0} may represent the gradients of the output of networks f₀(x) with respect to the parameters θ. D may represent the training set.

Given a final loss value [symbol] and learning rate η, the training dynamics for the weights and the final activations are, respectively, as follows:

$${\dot{w}}_{l} = - η {∇}_{θ} {{f}_{0} ( D )}^{T} {∇}_{{f}_{t}^{lin} ( D )} ℒ ;$$

$${\dot{f}}_{t}^{lin} ( x ) = - η {Θ}_{0} ( x , D ) {∇}_{{f}_{t}^{lin} ( D )} ℒ .$$

Here, ∇_{f}_{ₜ}_{^{lin}}_{(D)} [symbol] may be the gradients of loss value with respect to the output of networks fₜ(x).

The matrix Θ₀=∇_{θ}f₀(D)∇_{θ}f₀(D)^{T} of size c|D|×c|D|, where c is the number of classes, may be referred to as the Neural Tangent Kernel (NTK) matrix.

In accordance with aspects, ∇_{θ}f₀(D) may have a size c|D|×K, where K is the number of parameters for the neural network. Each row may contain the gradients of one output for one input with respect to the network parameters (i.e., K elements). Since, for each input the network has c outputs and there are |D| inputs, in total there are c|D| rows.

In accordance with aspects, a machine unlearning process may utilize two datasets, a forget dataset and a retain dataset. A forget dataset may include data that will be provided as input to a machine unlearning process. A machine unlearning process may be configured to partially or fully reverse any influence that the data included in a forget dataset previously had on a machine learning model. That is, the machine unlearning process is configured to manipulate the model so as to reverse any training of the model with respect to the forget dataset that resulted in the model learning (i.e., being configured through the training process) to generate output based on the data in the forget dataset. This may be referred to as the model “forgetting” or “unlearning” the data in the forget dataset.

A forget dataset may include “sensitive data.” As used herein, the term “sensitive data” refers to any data that an organization may want a machine learning model, such as a classification model, to forget or unlearn. While the term may refer to regulated data, such as personally identifiable information (PII), data governed by copyright law, or data subject to an organization's internal data governance policy, as used herein sensitive data may be any datum or dataset that an implementing organization includes in a forget dataset or is otherwise provided as input in a machine unlearning process in order to have a machine learning model forget or unlearn the sensitive data.

In accordance with aspects, data included in a retain dataset may be data that has been filtered to remove sensitive data (e.g., data that is included in, or is similar to data included in a forget dataset). Data in a retain dataset may be data that has been verified by an organization as acceptable data with which to train a machine learning model, or with which to leave a machine learning model trained on. Data in a retain dataset may be acceptable from a governmental, regulatory, organizational, or other standpoint. Data in a retain dataset may or may not include some data from a dataset that was initially used to train a machine learning model. Axiomatically, a retain dataset will not include data that is also included in a forget dataset and that will be used correspondingly with the retain dataset in a machine unlearning process, since a forget dataset and a retain dataset are mutually exclusive, by definition.

As used herein, the term “unfiltered dataset” refers to a dataset that includes both sensitive data and data that has been verified by an organization as acceptable data with which to train a machine learning model, or with which to leave a machine learning model trained on. An unfiltered dataset may be a dataset that was initially used to train a machine learning model or may include data that is similar to a dataset that a machine learning model was initially trained on. An unfiltered dataset may be partitioned into a retain dataset and a forget dataset.

In accordance with aspects, a machine unlearning process may include partitioning a dataset D (i.e., an unfiltered dataset) into a forget set D_{f} and a retain set Dᵣ. Using these dynamics, a final training point (e.g., a final training state of model parameters) may be approximated in closed form when training a model with D and Dᵣ. Moreover, an optimal “forgetting” vector may be computed that facilitates a shifting of the model weights from the weights θ_{D} that have been obtained by training on D (i.e., an initial training) to the weights θ_{D}_{ᵣ} that theoretically would have been obtained training on Dᵣ alone.

In accordance with aspects, given the L₂ regression loss, the unlearning procedure under an NTK approximation is given by:

θ_{D}_{ᵣ}=θ_{D}+P∇f₀(D_{f})^{T}MV.

Θᵣᵣ may be the NTK matrix on the retain set and Θ_{ff} may be the NTK matrix on the forget set. Additionally, Θ_{rf} may be the NTK matrix between the retain set and the forget set, which may be defined as:

$${Θ}_{rf} = {∇}_{θ} {f}_{0} ( {D}_{r} ) {∇}_{θ} {{f}_{0} ( {D}_{f} )}^{T} .$$

In aspects, Y_{f} and Yᵣ may be the labels for the forget set and retain set, respectively. ∇f₀(D_{f})^{T} may be the matrix whose columns are the gradients of the sample to forget, computed at θ₀ with size M×c|D_{f}|.

P=I−∇f₀(Dᵣ)^{T} Θᵣᵣᵣ⁻¹∇f₀(Dᵣ) may be a projection matrix, that projects the gradients of the samples to forget (i.e., Gf) from the orthogonal space to the space spanned by the gradients of all samples to retain.

Additionally:

$$M = {[ {Θ}_{ff} - {Θ}_{rf}^{T} {Θ}_{rr}^{- 1} {Θ}_{rf}^{T} ]}^{- 1}$$

$$and$$

$$V = [ ( {Y}_{f} - {f}_{0} ( {D}_{f} ) ) + {Θ}_{rf}^{T} {Θ}_{rr}^{- 1} ( {Y}_{r} - {f}_{0} ( {D}_{r} ) ) ] ,$$

where M and V together re-weight each direction before summing them together.

As noted above, the main challenge in NTK-based unlearning processes is the compute of the gradient matrix ∇_{θ}f(D). The matrix ∇_{θ}f(D) is of size c|D|×K, where K is the number of parameters. Typically, for a deep neural network, the value of K is significant, varying from millions to even trillions. To reduce the value of K, aspects may combine an NTK-based unlearning process with parameter-efficient fine-tuning methods. Accordingly, aspects may only tune the normalization layers of a convolution neural network and may use prompt-based fine-tuning for transformers. Employing these techniques, a value of K may be significantly reduced (e.g., up to 1000 times), thereby making NTK-based unlearning methods practical.

In accordance with aspects, for a typical convolution layer, where Cₒ is the number of output channels in the convolution layer; Cᵢ is the number of input channels; K is the kernel size (i.e., assuming a square kernel, K×K), and g is the number of separable convolution groups, then:

$${Parameters}_{conv} = \frac{{C}_{o} \times {C}_{i} \times {K}^{2}}{g} .$$

For a batch normalization (BN) layer, the forward computation is as follows:

$$BN ( {x}_{i} , {γ}_{i} , {β}_{i} , {μ}_{i} , {σ}_{i} ) = {γ}_{i} \frac{{x}_{i} - {μ}_{i}}{{σ}_{i}} + {β}_{i} = {\overline{x}}_{i} ,$$

where xᵢ is the input and i is the channel index. Further, μᵢ and σᵢ are the input statistics. The only learnable parameters, then, are the scaling (γ) and shifting (β) terms for each channel. So, the total parameters for a BN layer following a convolution layer with Cₒ channels would be:

$${Parameters}_{BN} = 2 \times {C}_{o} .$$

Generally, Cᵢ×K² is much larger than 2 and g=1; therefore:

$$\frac{{Parameters}_{conv}}{{Parameters}_{BN}} = \frac{{C}_{i} \times {K}^{2}}{2 g} ≫ 1.$$

In accordance with aspects, in image classification transformers, an input embedding layer transforms an input image into a sequence-like output feature h∈R^{L×E}, where L is the sequence length and E is the embedding dimension. When solving downstream tasks, the pre-trained backbone model is kept frozen as a general feature extractor, and the prompt parameters p∈R^{L}^{ₚ}^{×E} with sequence length Lₚ and embedding dimension E are prepended to the embedding feature along the sequence length dimension to form the extended embedding feature. Finally, the extended feature is sent to the rest of the model for performing classification tasks. A prompt serves as a lightweight module to encode high-level instruction that instructs the backbone model to leverage pre-trained representations for downstream tasks.

In accordance with aspects, given a pre-trained transformer model f with N consecutive MSA layers, the input embedding feature of the i-th MSA layer may be denoted as h⁽ⁱ⁾, i=1, 2, . . . , N. Specifically, applying a prompting function can be viewed as modifying the inputs of the MSA layers. Accordingly, the input to the MSA layer may be h∈R^{L×E}, and the input query, key, and values for the MSA layer may be denoted as h_{Q}, h_{K}, and h_{V}, respectively. The MSA layer may be denoted as

$$MSA ( {h}_{Q} , {h}_{K} , {h}_{V} ) = Concat ( {h}_{1} , … , {h}_{m} ) {W}^{o} ,$$

$$where$$

$${h}_{i} = Attention ( {h}_{Q} {W}_{i}^{Q} , {h}_{K} {W}_{i}^{K} , {h}_{V} {W}_{i}^{V} ) ,$$

and where W^{O}, Wᵢ^{Q}, Wᵢ^{K}, and Wᵢ^{V} are projection matrices, and m is the number of heads.

In accordance with aspects, prompt-based tuning divides prompt parameters p into p_{K},

$${p}_{V} ∈ {R}^{\frac{{L}_{p}}{2} \times E} ,$$

and prepends the parameters to h_{K} and h_{V} respectively, while keeping h_{Q} as-is:

$${f}_{prompt} ( p , h ) = MSA ( {h}_{Q} , Concat ( {p}_{K} , {h}_{K} ) , Concat ( {p}_{V} , {h}_{V} ) ) .$$

The output sequence length remains the same as the input to the MSA layer (i.e., h∈R^{L×E}).

With respect to a parameter count of an MSA layer, it may be given that m is the number of attention heads and E is the embedding dimension. Further, each attention head may have three weight matrices (i.e., W^{Q}, W^{K}, and W^{V} of size

$$\frac{E}{m} \times E ) ,$$

and an output matrix W^{O} of size E×E. Then, the number of parameters in an MSA layer may be written as:

$${Parameters}_{MSA} = 3 m \frac{E}{m} \times E + E \times E = 4 {E}^{2} .$$

In contrast, prompt-based tuning only has Lₚ×E learnable parameters. Typically, the embedding dimensions E is much higher than the prompt length Lₚ. Accordingly,

$$\frac{{Parameters}_{MSA}}{{Parameters}_{prompt}} = \frac{4 E}{{L}_{p}} .$$

Thus, it can be shown that, in general, tuning an entire MSA would involve significantly more parameters as compared to tuning only the included prompts.

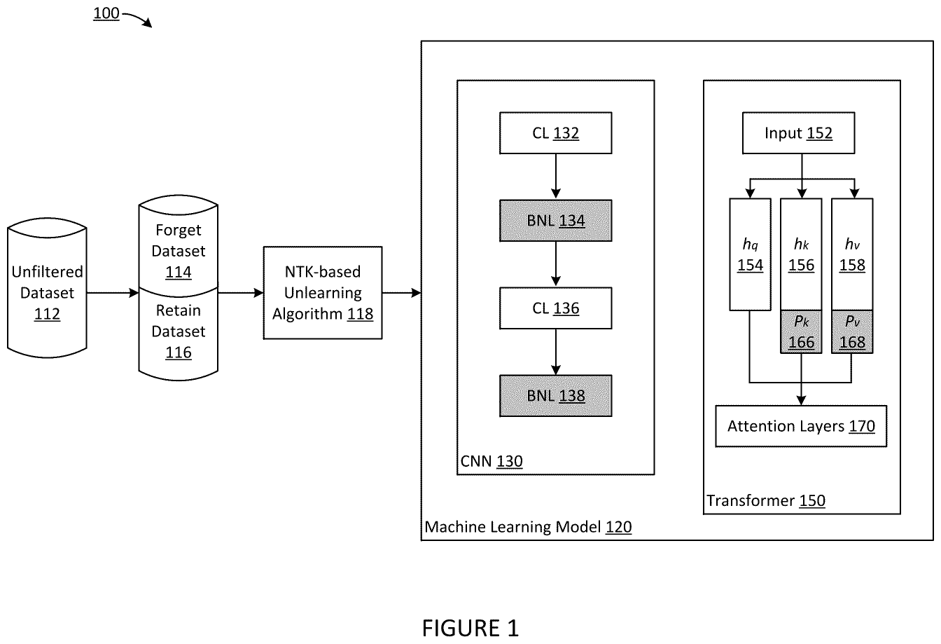

FIG. 1 is a block diagram of a system for efficient machine unlearning, in accordance with aspects. Machine unlearning system 100 includes unfiltered dataset 112, forget dataset 114, retain dataset 116, NTK-based unlearning algorithm 118, and machine learning model 120. Machine learning model 120 is a machine learning model that includes CNN 130 and transformer 150. Machine learning model 120 may be, e.g., a classifier or classification machine learning model. CNN 130 is a convolutional neural network and transformer 150 is a transformer model (e.g., a vision transformer or image classification transformer).

In accordance with aspects, unfiltered dataset 112 may be an unfiltered dataset as describe herein and may include data that may be partitioned into a retain data set and a forget dataset. Unfiltered dataset 112 may be partitioned into forget dataset 114 and retain dataset 116. Forget dataset 114 may include sensitive data from unfiltered dataset 112 and retain dataset 116 may include data that has been verified by an organization as acceptable data with which to train a machine learning model, or with which to leave a machine learning model trained on.

In accordance with aspects, NTK-based unlearning algorithm 118 is a neural-tangent-kernel-based configured as described in detail herein. NTK-based unlearning algorithm 118 may have access to and/or be in operational communication with forget dataset 114 and retain dataset 116. NTK-based unlearning algorithm 118 may be configured to utilize forget dataset 114 and retain dataset 116 to tune parameters of machine learning model 120 as described herein. In accordance with aspects, NTK-based unlearning algorithm 118 may be configured to tune only the parameters included in the shaded components of machine learning model 120, while leaving parameters of the unshaded components fixed (i.e., unchanged).

In accordance with aspects, CNN 130 includes CL 132 and CL 136. CL 132 and CL 136 are convolutional layers of CNN 130 and include corresponding parameters. CNN 130 also includes BNL 134 and BNL 138. BNL 134 and BNL 138 are batch normalization layers of CNN 130. In a tuning process, NTK-based unlearning algorithm 118 may be configured to tune only BNL 134 and/or BNL 138 as described herein.

In accordance with aspects, transformer 150 includes input 152, h_{q} 154, hₖ 156, and hᵥ 158. h_{q} 154, hₖ 156, and hᵥ 158 are MSA layers of transformer 150 and include corresponding parameters. Pₖ 166 and Pᵥ 168 are prompts of transformer 150. Pₖ 166 and Pᵥ 168 may include prompt parameters. Pₖ 166 and Pᵥ 168 may be sets of prompt parameters that have been divided into Pₖ 166 and Pᵥ 168 from a larger set as described in more detail, herein. Pₖ 166 and Pᵥ 168 are prepended to hₖ 156 and hᵥ 158, respectively, as described in more detail, herein. Transformer 150 further includes attention layers 170, and includes corresponding parameters. IN a tuning process, NTK-based unlearning algorithm 118 may be configured to tune parameters of BNL 134, BNL 138, Pₖ 166, and Pᵥ, while leaving the parameters of all other components of CNN 130 and transformer 150 fixed, as described herein.

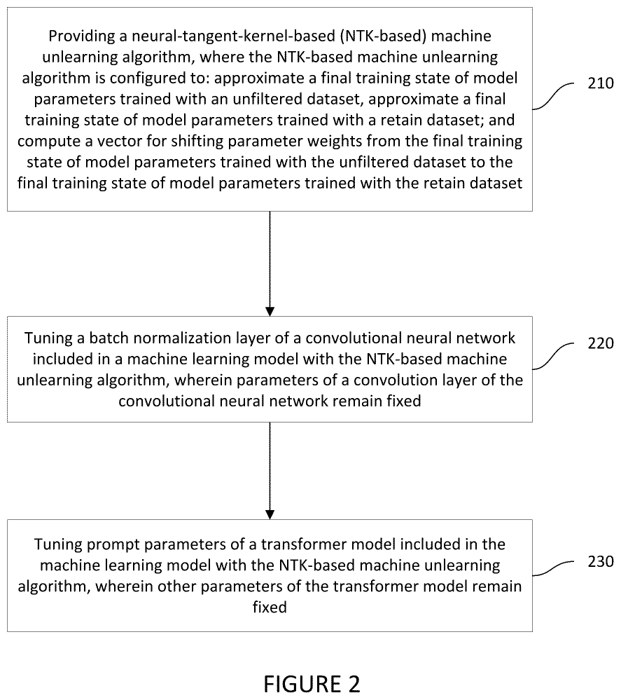

FIG. 2 is a logical flow for efficient machine unlearning, in accordance with aspects.

Step 210 includes a neural-tangent-kernel-based (NTK-based) machine unlearning algorithm, wherein the NTK-based machine unlearning algorithm is configured to: approximate a final training state of model parameters trained with an unfiltered dataset, approximate a final training state of model parameters trained with a retain dataset; and compute a vector for shifting parameter weights from the final training state of model parameters trained with the unfiltered dataset to the final training state of model parameters trained with the retain dataset.

Step 220 includes tuning a batch normalization layer of a convolutional neural network included in a machine learning model with the NTK-based machine unlearning algorithm, wherein parameters of a convolution layer of the convolutional neural network remain fixed.

Step 230 includes tuning prompt parameters of a transformer model included in the machine learning model with the NTK-based machine unlearning algorithm, wherein other parameters of the transformer model remain fixed.

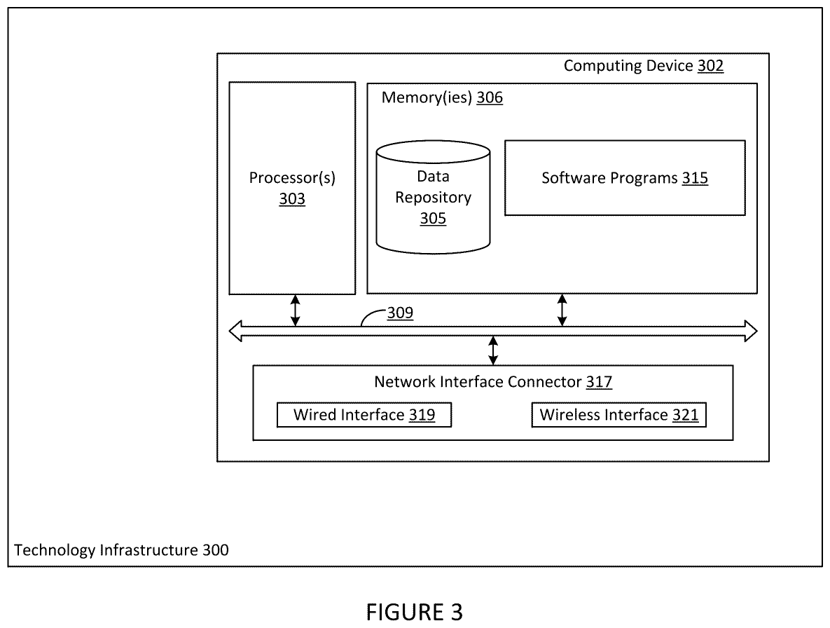

FIG. 3 is a block diagram of a technology infrastructure and computing device for implementing certain aspects of the present disclosure, in accordance with aspects. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with aspects, system components such as a machine unlearning algorithm, a modeling engine, a machine learning model and components thereof, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services, modules, engines, etc., that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
providing a neural-tangent-kernel-based (NTK-based) machine unlearning algorithm, wherein the NTK-based machine unlearning algorithm is configured to:
approximate a final training state of model parameters trained with an unfiltered dataset;
approximate a final training state of model parameters trained with a retain dataset; and
compute a vector for shifting parameter weights from the final training state of model parameters trained with the unfiltered dataset to the final training state of model parameters trained with the retain dataset;
tuning a batch normalization layer of a convolutional neural network included in a machine learning model with the NTK-based machine unlearning algorithm, wherein parameters of a convolution layer of the convolutional neural network remain fixed; and
tuning prompt parameters of a transformer model included in the machine learning model with the NTK-based machine unlearning algorithm, wherein other parameters of the transformer model remain fixed.

2. The method of claim 1, comprising:
partitioning the unfiltered dataset into a forget dataset and the retain dataset;

3. The method of claim 1, wherein the other parameters of the transformer model include parameters of an attention layer and parameters of an MSA layer.

4. The method of claim 3, wherein the MSA layer includes an input query, a key, and values.

5. The method of claim 4, wherein the prompt parameters of the transformer model are divided into key prompts and value prompts, and wherein the key prompts are prepended to the key of the MSA layer and the value prompts are prepended to the values of the MSA layer.

6. The method of claim 2, wherein the NTK-based machine unlearning algorithm includes a matrix between the retain dataset and the forget dataset.

7. The method of claim 6, wherein the matrix between the retain dataset and the forget dataset includes a matrix whose columns are gradients of a sample from the forget dataset.

8. A system comprising at least one computer including a processor and a memory, wherein the at least one computer is configured to:
execute a neural-tangent-kernel-based (NTK-based) machine unlearning algorithm, wherein the NTK-based machine unlearning algorithm is configured to:
approximate a final training state of model parameters trained with an unfiltered dataset;
approximate a final training state of model parameters trained with a retain dataset; and
compute a vector for shifting parameter weights from the final training state of model parameters trained with the unfiltered dataset to the final training state of model parameters trained with the retain dataset;
tune a batch normalization layer of a convolutional neural network included in a machine learning model with the NTK-based machine unlearning algorithm, wherein parameters of a convolution layer of the convolutional neural network remain fixed; and
tune prompt parameters of a transformer model included in the machine learning model with the NTK-based machine unlearning algorithm, wherein other parameters of the transformer model remain fixed.

9. The system of claim 8, wherein the at least one computer is configured to:
partition the unfiltered dataset into a forget dataset and the retain dataset;

10. The system of claim 8, wherein the other parameters of the transformer model include parameters of an attention layer and parameters of an MSA layer.

11. The system of claim 10, wherein the MSA layer includes an input query, a key, and values.

12. The system of claim 11, wherein the prompt parameters of the transformer model are divided into key prompts and value prompts, and wherein the key prompts are prepended to the key of the MSA layer and the value prompts are prepended to the values of the MSA layer.

13. The system of claim 9, wherein the NTK-based machine unlearning algorithm includes a matrix between the retain dataset and the forget dataset.

14. The system of claim 13, wherein the matrix between the retain dataset and the forget dataset includes a matrix whose columns are gradients of a sample from the forget dataset.

15. A non-transitory computer readable storage medium, including instructions stored thereon, which instructions, when read and executed by one or more computer processors, cause the one or more computer processors to perform steps comprising:
providing a neural-tangent-kernel-based (NTK-based) machine unlearning algorithm, wherein the NTK-based machine unlearning algorithm is configured to:
approximate a final training state of model parameters trained with an unfiltered dataset;
approximate a final training state of model parameters trained with a retain dataset; and
compute a vector for shifting parameter weights from the final training state of model parameters trained with the unfiltered dataset to the final training state of model parameters trained with the retain dataset;
tuning a batch normalization layer of a convolutional neural network included in a machine learning model with the NTK-based machine unlearning algorithm, wherein parameters of a convolution layer of the convolutional neural network remain fixed; and
tuning prompt parameters of a transformer model included in the machine learning model with the NTK-based machine unlearning algorithm, wherein other parameters of the transformer model remain fixed.

16. The non-transitory computer readable storage medium of claim 15, comprising:
partitioning the unfiltered dataset into a forget dataset and the retain dataset;

17. The non-transitory computer readable storage medium of claim 15, wherein the other parameters of the transformer model include parameters of an attention layer and parameters of an MSA layer.

18. The non-transitory computer readable storage medium of claim 17, wherein the MSA layer includes an input query, a key, and values.

19. The non-transitory computer readable storage medium of claim 18, wherein the prompt parameters of the transformer model are divided into key prompts and value prompts, and wherein the key prompts are prepended to the key of the MSA layer and the value prompts are prepended to the values of the MSA layer.

20. The non-transitory computer readable storage medium of claim 16, wherein the NTK-based machine unlearning algorithm includes a matrix between the retain dataset and the forget dataset, and wherein the matrix between the retain dataset and the forget dataset includes a matrix whose columns are gradients of a sample from the forget dataset.
